(19) United States
(12) Patent Application Publication
(10) Pub. No.: US 2006/0128402 A1
(43) Pub. Date: Jun. 15, 2006

(54) Method of implementing scatternet in wireless personal area network

(75) Inventors: Hyeon Seok Lee, Seoul (KR); Jin Woong Cho, Yongin (KR); Sun Do June, Seoul (KR); Kyu Jung Youn, Seoul (KR); Yun Jae Won, Yongin (KR); Tai Gil Kwon, Sungnam (KR)

Correspondence Address: SUGHRUE MION, PLLC, 2100 PENNSYLVANIA AVENUE, N.W., SUITE 800, WASHINGTON, DC, 20037, US

(73) Assignee: KOREA ELECTRONICS TECHNOLOGY INSTITUTE

(21) Appl. No.: 11/271,780

(22) Filed: Nov. 14, 2005

(30) Foreign Application Priority Data
Dec. 14, 2004 (KR) KR10-2004-0105436

(51) Int. Cl. H04Q 7/20

(52) U.S. Cl. 455/464

(57) ABSTRACT

The present invention relates to a method of implementing a scatternet over a plurality of piconets using different frequencies in a Wireless Personal Area Network (WPAN). In the scatternet implementation method of the present invention, a master of a first piconet transmits a scatternet request to a shared slave, and the shared slave switches a frequency thereof to a frequency of a second piconet and relays the scatternet request to a master of the second piconet. The master of the second piconet transmits scatternet approval to the shared slave. The shared slave switches the frequency to a frequency of the first piconet, relays the scatternet approval to the master of the first piconet, and is allocated resources, which do not overlap each other, by the masters of the first piconet and the second piconet. The shared slave switches frequencies and relays data between the first piconet and the second piconet while synchronizing with both the first piconet and the second piconet using allocated resources.

Related Applications

The present disclosure relates to subject matter contained in priority Korean Application No. 10-2004-0105436 filed on 14 Dec. 2004, which is herein expressly incorporated by reference in its entirety.

### BACKGROUND OF THE INVENTION

1. Field of the Invention

The present invention relates, in general, to IEEE 802.15.3 communication systems which comply with a high rate wireless personal area network standard and, more particularly, to a method of implementing a scatternet for data transmission between piconets using different frequencies.

2. Description of the Related Art

The IEEE 802.15 working group establishes the standard of a Wireless Personal Area Network (WPAN) composed of movable computing devices in a network implemented within a short distance, such as a PAN. Recently, efforts to apply WPAN to home automation, remote control, a ubiquitous sensor network, etc. have been made.

In particular, the IEEE 802.15.3 standard, which has recently been completed, has been designated as a High Rate-WPAN (HR-WPAN), and is intended to implement a wireless communication network suitable for applications requiring a high data rate of 55 Mbps or above. The IEEE 802.15.3 standard has characteristics, such as a short distance of 5 m to 55 m, a data rate of 55 Mbps or above, the dynamic topology of devices constituting a network, the support of Time Division Multiple Access (TDMA) for guaranteeing the Quality of Service (QoS) of streams, and Peer-to-Peer connectivity, so as to transmit wireless multimedia data in a home network.

(Characteristics of WPAN)

A Wireless Personal Area Network (WPAN) denotes a wireless ad-hoc or data communication system in which a plurality of independent stations can transmit typical data, and voice and multimedia data. Such a system defines a radius of personal movement, that is, all directions within a distance of 10 m, as a communication area, and is capable of providing data transmission service required by a person, such as the transmission of voice data, video streams or typical data.

A basic communication range of a WPAN is based on a personal working area within a short distance of 10 m, as described above. The WPAN can operate in conjunction with a wired network, such as a Local Area Network (LAN), a Metropolitan Area Network (MAN), or a Wide Area Network (WAN), or a wireless network, such as a Wireless LAN.

Generally, addresses allocated to each station in a wired network, such as Ethernet connected in a wired manner, do not change, but addresses in the WPAN designate data transmission/reception stations, to which service is provided, and are typically dynamically allocated according to circumstances, without being fixed.

Meanwhile, the WPAN can provide service to fixed, portable and mobile devices. One of the important features of portable and mobile devices is that a power source is implemented with a battery. Accordingly, due to the limited power capacity of the battery, efficient power management technology is very important, and the efficient design of protocols for a physical layer or data link layer, as well as the design of parts or circuits, is also important so as to reduce power consumption.

(Components of WPAN)

FIG. 1 is a diagram showing an example of the configuration of a WPAN. The components constituting the WPAN can be schematically classified as follows. A basic component is a station, and a piconet is configured when two or more stations, operating in the same wireless frequency channel, exist in the area of activity of a person. Stations are classified into a master and a slave depending on the function thereof. A master manages an entire piconet, and only one master may exist in a piconet. The master broadcasts beacons to control slaves. The slaves can transmit/receive data under the control of the master.

(Function of WPAN)

1. Network Synchronization

A piconet is activated by a master transmitting a beacon packet. The beacon packet includes reference information about a network. All slaves in the piconet realize network synchronization using reference information included in the beacon packet. A superframe is composed of three parts, that is, a beacon period (Beacon), a Contention Access Period (CAP) and a Contention Free Period (CFP), as shown in FIG. 2. The length of each period is variable.

First, during the beacon period, the master broadcasts beacon packets, having network reference information, to slaves.

During the CAP, the slaves and the master transmit command packets, such as packets for network join/unjoin request/approval, resource allocation request/approval or connection request/approval, in a random access manner. During the CFP, exclusive access to a medium through the exclusive allocation of time by the master is not guaranteed, so each station accesses a medium using Carrier Sensing Multiple Access/Collision Avoidance (CSMA/CA) based on a contention mode. Accordingly, each station transmits a packet when a required packet to be transmitted exists and a medium is empty for a backoff time.

FIG. 3 is a timing diagram when a packet is transmitted or received during the CAP. Referring to FIG. 3, the CAP starts at a Short Inter-Frame Space (SIFS) which is one of Inter-Frame Spaces (IFS), and each SIFS exists between each data frame and each ACK frame. Accordingly, sufficient turn-around time can be guaranteed between frames to be transmitted. A backoff period starts at a Backoff Inter-Frame Space (BIFS), and a frame is transmitted when a medium is empty during the backoff period. Meanwhile, a guard time exists to prevent a collision between neighboring time slots (Channel Time Allocations: CTAs).

Referring to FIG. 2, during a CFP, a station allocated a time slot (CTA) using a Time Division Multiple Access (TDMA) mode transmits synchronous/asynchronous data and command packets for the corresponding time slot. For example, in FIG. 2, during a CFP for an m-th superframe SF m, n time slots CTA1, CTA2, . . . , CTA n−1 and CTA n are allocated in a time division manner, and each guard time is inserted between neighboring time slots.

During the CFP, each station exclusively accesses a medium for a time slot allocated thereto. The master distributes the time slots of the CFP to respective stations. For each distributed time slot, a corresponding station can exclusively access a medium and can exchange data with a required station without the intervention of the master in a one-to-one manner. The master designates the start time and length of a corresponding time slot and transmission/reception stations in a beacon packet, thus guaranteeing exclusive access to a medium by each station so as to transmit a packet. Through this guarantee, each station can recognize the time to transmit or receive a packet.

FIG. 4 is a diagram showing, in detail, timing and frame intervals when a plurality of frames is transmitted during a CFP.

As shown in FIG. 4, in an n-th time slot CTA n, the above-described SIFSs exist between respective data frames 1, 2 and 3 and ACK frames therefor, and the above-described guard time exists between a time slot CTA n and a time slot CTA n−1.

2. Data Transmission

In order to transmit data, a WPAN provides two types of connections, that is, synchronous and asynchronous connections. The asynchronous connection reduces the load at the time of creating a connection, but does not guarantee a bandwidth, and is mainly used to transmit typical data that are relatively insensitive to time delay. In contrast, the synchronous connection increases the load at the time of creating a connection, but guarantees bandwidth, and is mainly used to transmit data related to real-time service, for example, audio or video data.

3. Power Management

In a WPAN supporting mobile devices, it is most important to efficiently manage power. Each station can recognize the existence of data to be transmitted thereto in a corresponding superframe and the transmission time of data, through a beacon packet, and can inactivate a physical layer, except for the time for which data are received or transmitted, thus reducing power consumption. A station, which does not receive data during a corresponding superframe period, is inactivated until the subsequent superframe starts. A station, having data to be received, is activated only during a beacon period and a period in which frames that the station will receive, exist. A station desiring to transmit data or request a command is activated during a period in which data to be transmitted exist.

FIG. 5 is a diagram showing an example of the case in which a scatternet is implemented over two piconets using different frequencies. When communication is required between two piconets, a scatternet can be used.

Referring to FIG. 5, a piconet_a includes a master node and four slave nodes A_1 to A_4, and uses a channel having a frequency of freq_a. Further, a piconet_b includes a master node and four slave nodes B_1 to B_4, and uses a channel having a frequency of freq_b. In this case, since the slave node A_3 of the piconet_a is connected to the slave node B_5 of the piconet_b, the piconets can communicate with each other at different frequencies through the slave nodes included therein. Accordingly, the master node and the slave nodes A_1, A_2 and A_4 of the piconet_a use the slave node A_3 as a shared node, so that the master node and slave nodes of the piconet_a can communicate with the master node and the slave nodes B_1 to B_4 of the piconet_b having another usage frequency. In this way, a structure in which a plurality of piconets constitutes a single network through a shared node is designated a scatternet.

However, a conventional wireless LAN (IEEE 802.11) does not include the concept of a scatternet, and can only communicate with a device in another network using a wired infrastructure called an Access Point (AP). In a typical ad-hoc communication mode, the transmission of data is possible only between devices having the same frequency. Even under the IEEE 802.15.3 standard, which defines an ad-hoc mode, a procedure of performing scatternet communication between piconets using different frequencies is not sufficiently provided for.

### SUMMARY OF THE INVENTION

Accordingly, the present invention has been made keeping in mind the above problems occurring in the prior art, and an object of the present invention is to provide a method of implementing a scatternet, which can efficiently perform scatternet communication between piconets using different frequencies in IEEE 802.15.3 communication.

In accordance with a first aspect of the present invention to accomplish the above object, there is provided a method of implementing a scatternet over a plurality of piconets using different frequencies in a Wireless Personal Area Network (WPAN). The scatternet implementation method comprises the steps of (a) a master of a first piconet transmitting a scatternet request to a shared slave, and the shared slave switching a frequency thereof to a frequency of a second piconet and relaying the scatternet request to a master of the second piconet; (b) the master of the second piconet transmitting scatternet approval to the shared slave; (c) the shared slave switching the frequency to a frequency of the first piconet, relaying the scatternet approval to the master of the first piconet, and being allocated resources, which do not overlap each other, by the masters of the first piconet and the second piconet; and (d) the shared slave switching frequencies and relaying data between the first piconet and the second piconet while synchronizing with both the first piconet and the second piconet using allocated resources.

Preferably, the scatternet request may include information about a length of a superframe of the first piconet, and the step (b) may comprise the step of (e) the master of the second piconet adjusting a length of a superframe of the second piconet to the same value as the length of the superframe of the first piconet. Preferably, the step (c) may comprise the steps of (f) the shared slave switching the frequency to the frequency of the first piconet, relaying the scatternet request to the master of the first piconet, and being allocated resources by the first piconet; and (g) the shared slave switching the frequency to the frequency of the second piconet after step (f), and being allocated resources, which do not overlap the resources allocated by the first piconet, by the master of the second piconet.

Preferably, at step (d), a synchronization procedure may not be performed when frequencies are switched between the first piconet and the second piconet to initiate communication.

In accordance with a second aspect of the present invention, there is provided a method of implementing a scatternet over a plurality of piconets performing IEEE 802.15.3 communication using different frequencies. The scatternet implementation method comprises the steps of (a) a master of a first piconet transmitting a scatternet request to a shared slave, and the shared slave switching a frequency thereof to a frequency of a second piconet and relaying the scatternet request to a master of the second piconet; (b) the master of the second piconet transmitting scatternet approval to the shared slave; (c) the shared slave switching the frequency to a frequency of the first piconet, relaying the scatternet approval to the master of the first piconet, and being allocated resources, which do not overlap each other, by the masters of the first piconet and the second piconet; and (d) the shared slave switching frequencies and relaying data between the first piconet and the second piconet while synchronizing with both the first piconet and the second piconet using allocated resources.

In accordance with a third aspect of the present invention, there is provided a method of implementing a scatternet over a plurality of piconets performing IEEE 802.15.3 communication using different frequencies. The scatternet implementation method comprises the steps of (a) a master of a first piconet transmitting a scatternet request to a shared slave, and the shared slave switching a frequency thereof to a frequency of a second piconet and relaying the scatternet request to a master of the second piconet; (b) the master of the second piconet transmitting scatternet approval to the shared slave; (c) the shared slave switching the frequency to the frequency of the first piconet and relaying the scatternet approval to the master of the first piconet; and (d) the shared slave performing synchronization at the time of switching frequencies between the first and second piconets, and relaying data between the first and second piconets using resources allocated through the synchronization.

### BRIEF DESCRIPTION OF THE DRAWINGS

FIG. 1 is a diagram showing an example of the configuration of a wireless personal area network;

FIG. 2 is a diagram showing the entire configuration of a superframe;

FIG. 3 is a diagram showing the configuration of a Contention Access Period (CAP) using a Carrier Sensing Multiple Access/Collision Avoidance (CSMA/CA) mode;

FIG. 4 is a diagram showing the configuration of time slots in a Contention Free Period (CFP);

FIG. 5 is a diagram showing an example in which two piconets overlap each other to implement a scatternet;

FIG. 6 is a timing diagram showing an example of scatternet communication using two pieces of synchronization information according to a first embodiment of the present invention;

FIG. 7 is a timing diagram showing an example of scatternet communication using a piece of synchronization information according to a second embodiment of the present invention;

FIG. 8 is a timing diagram showing another example of scatternet communication using a piece of synchronization information according to a second embodiment of the present invention; and

FIG. 9 is a flowchart showing a message flow for implementing a scatternet according to a first embodiment of the present invention.

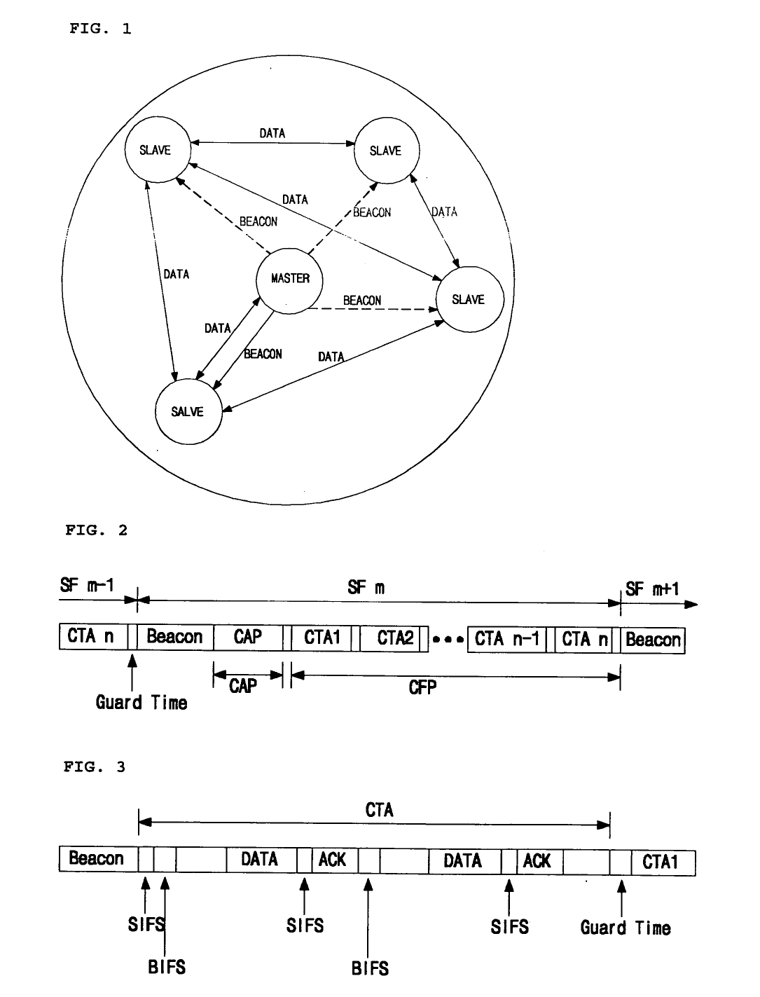

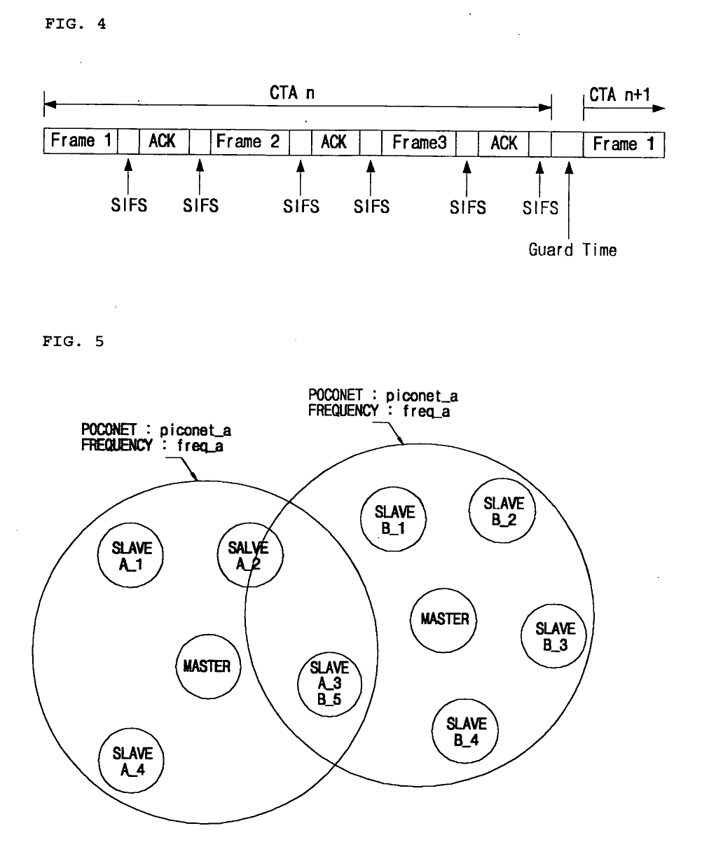

### DESCRIPTION OF THE PREFERRED EMBODIMENTS

Hereinafter, embodiments of the present invention will be described in detail with reference to the attached drawings.

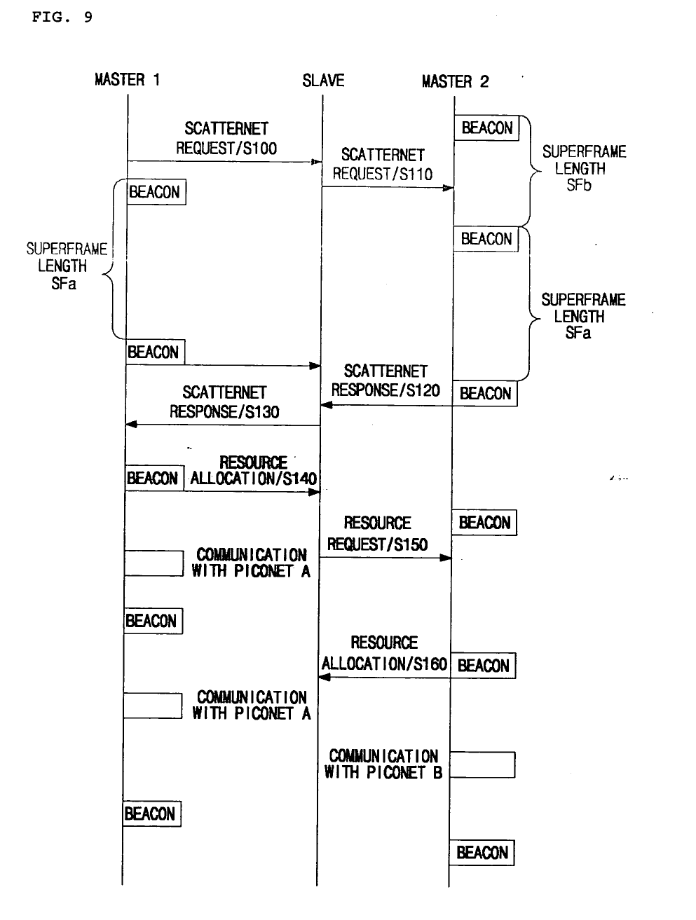

FIG. 9 is a flowchart schematically showing a message flow for implementing a scatternet according to a first embodiment of the present invention. In FIG. 9, it is assumed that the master of a piconet A (master 1) recognizes a piconet to which a desired station to be found belongs, through a remote scan. The remote scan is defined in the IEEE 802.15.3 standard.

First, the master 1 transmits a scatternet request frame to a slave belonging both to piconet A and piconet B at step S100. The slave, having received the scatternet request frame, relays the scatternet request frame to the master of piconet B (master 2) at step S110. The scatternet request frame may include information, such as the start time and period of a superframe, a usage frequency, etc.

The master 2, having received the scatternet request frame, transmits a scatternet response frame indicating whether to approve the implementation of a scatternet at step S120. That is, when denying the implementation of a scatternet, the master 2 transmits a scatternet response frame indicating denial, while when approving the implementation of a scatternet, the master 2 transmits a scatternet response frame indicating approval. In this case, when approving the scatternet request, the master 2 can adjust a superframe depending on information of the scatternet request frame so that the scatternet communication period of the slave does not overlap that of piconet A. That is, the master 2 sets the length of the superframe (SFb) thereof to the same value as the length of the superframe (SFa) of piconet A, and can adjust the superframe so that the start time of the superframe of the master 2 does not overlap that of the superframe of the master

The slave, having received the scatternet response frame, relays the scatternet response frame to the master 1 at step S130. The master 1, having received the scatternet response frame indicating a success, allocates resources through a beacon frame at step S140. Next, the slave transmits a resource allocation request frame to the master 2, together with the resources allocated by the master 1, that is, information about a time slot, at step S150. The master 2, having received the resource allocation request frame, allocates resources through a beacon frame so that the resources do not overlap the resources allocated to the slave by the master 1 at step S160.

Meanwhile, the above-described resource allocation steps S140 to S160 are performed after the slave relays the scatternet response frame to the master 1. Accordingly, as described above, it is preferable to first request resource allocation from the master 1 because the frequency switching of the slave is not required. However, the sequence of resource allocation performed by the master 1 and master 2 can be changed.

The slave manages information about the resources, allocated by piconet A and piconet B through the above-described resource allocation steps S140 to S160 so that the resources do not overlap each other. Accordingly, there is no need to perform a synchronization procedure each time, even though the frequency is changed to communicate with each piconet during scatternet communication.

The above-described scatternet request/response procedure and the resource allocation procedure are completed, thus the slave can communicate with piconet A or piconet B using different frequencies while synchronizing with piconet A and piconet B using the allocated resources. That is, the slave is allocated time slots, which do not overlap each other, by piconet A and piconet B and manages (maintains) synchronization information with the two piconets. Accordingly, when frequencies are switched between piconet A and piconet B to perform scatternet communication, a separate synchronization process may be omitted.

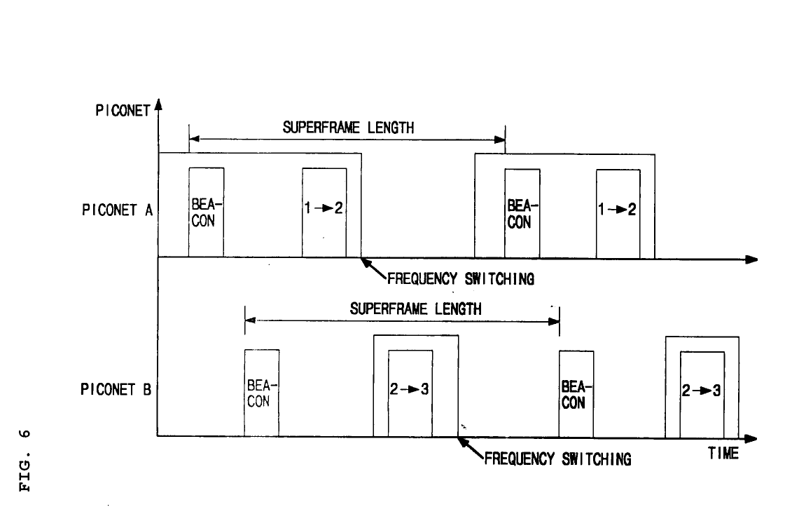

FIG. 6 is a timing diagram showing an embodiment in which a slave, obtaining two pieces of synchronization information based on the message flow of FIG. 9, performs scatternet communication.

Referring to FIG. 6, a slave connected to both of two piconets (piconet A and piconet B), operating at different frequencies, (hereinafter referred to as a “shared slave”) performs communication using a frequency used in piconet A during a period 1->2, switches its frequency to a frequency used in piconet B and performs communication during a period 2->3. In this case, the slave, performing scatternet communication, can manage synchronization information about the two piconets, as described above with reference to FIG. 9.

That is, the shared slave receives synchronization information for scatternet communication, for example, the start time and period of a superframe or an allocated time slot, through a negotiation procedure (steps S100 to S160 of FIG. 9) with the masters of piconet A and piconet B at the time of implementing a scatternet. Accordingly, as shown in FIG. 6, the shared slave manages the two pieces of information during scatternet communication, so that the shared slave changes only the frequency without requiring a separate synchronization procedure, thus performing scatternet communication during a corresponding slot period.

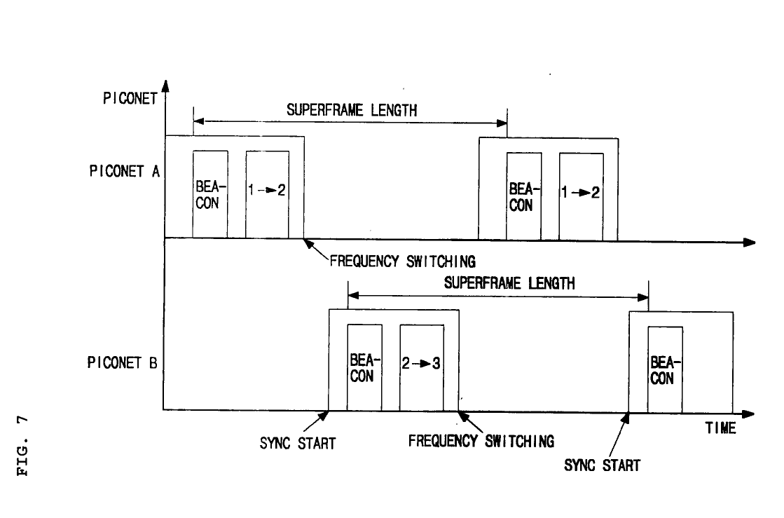

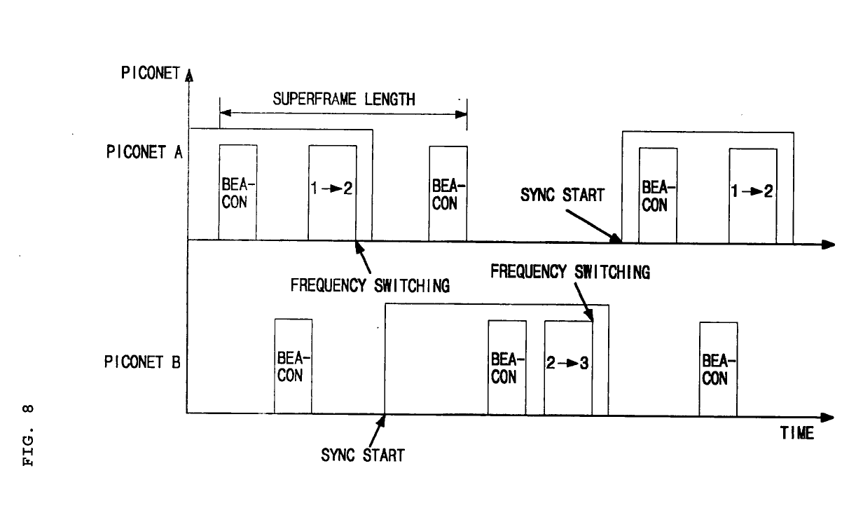

Meanwhile, a method of implementing a scatternet when a piconet, having received a scatternet request, does not or cannot perform superframe synchronization and/or non-overlapped resource allocation in FIG. 9 is described with reference to FIGS. 7 and 8.

FIG. 7 is a timing diagram showing an example of scatternet communication using a piece of synchronization information.

As shown in FIG. 7, the shared slave performs a synchronization procedure with the master of a corresponding piconet at the time of switching a frequency for scatternet communication. This operation is described in detail. After the shared slave receives data to be relayed to piconet B from piconet A during the period 1->2, the shared slave switches a frequency and performs a synchronization procedure with piconet B so as to be allocated a time slot of a CFP by the master of piconet B. The shared slave transmits the above-described relay data to a corresponding slave of piconet B during the period 2->3 allocated through the beacon of piconet B in the synchronization procedure. Then, the shared slave can switch a frequency and receive data from piconet A through a synchronization procedure with piconet A. Meanwhile, the case in which data are received from piconet A and are relayed to piconet B is described as an example. Even in the opposite case, the process can be applied in the same manner.

As described above, a method of performing scatternet communication using a piece of synchronization information does not require superframe synchronization and/or non-overlapped resource allocation described in FIGS. 6 and 9.

FIG. 8 is a timing diagram showing another example of scatternet communication using a piece of synchronization information, similar to FIG. 7. However, FIG. 8 shows the case in which data cannot be transmitted during a single superframe period at the time of scatternet communication, unlike the case of FIG. 7.

Referring to FIG. 8, after the shared slave receives data to be relayed to piconet B from piconet A during a period 1->2, the shared slave switches its frequency and performs a synchronization procedure with piconet B so as to be allocated a time slot of a CFP by the master of piconet B. For this operation, the shared slave receives the beacon of piconet B, and transmits the data to piconet B during a time slot (period 2->3) allocated through the beacon. Then, the shared slave receives data during the period 1->2 for piconet A again through a synchronization procedure with piconet A. In this case, since the shared slave cannot receive a second beacon from piconet A during the synchronization procedure with piconet B in FIG. 8, piconet A cannot perform scatternet communication during a second superframe period corresponding to the second beacon. After a synchronization procedure for a third superframe has been performed, piconet A performs scatternet communication.

FIG. 8 only shows that the case, in which scatternet communication cannot be performed during some superframe period due to the difference between the superframe periods of two piconets constituting the scatternet, may occur. However, the process or method for implementing the scatternet is the same as that of FIG. 7.

As described above, the present invention provides a method of implementing a scatternet, which can perform scatternet communication between piconets using different frequencies in IEEE 802.15.3 communication. In particular, there is an advantage in that scatternet communication can be performed when synchronization information only for a single piconet is managed according to a second embodiment of the present invention, as well as when synchronization information is obtained from both piconets according to a first embodiment of the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of implementing a scatternet over a plurality of piconets using different frequencies in a Wireless Personal Area Network (WPAN), comprising the steps of:
(a) a master of a first piconet transmitting a scatternet request to a shared slave, and the shared slave switching a frequency thereof to a frequency of a second piconet and relaying the scatternet request to a master of the second piconet;
(b) the master of the second piconet transmitting scatternet approval to the shared slave;
(c) the shared slave switching the frequency to a frequency of the first piconet, relaying the scatternet approval to the master of the first piconet, and being allocated resources, which do not overlap each other, by the masters of the first piconet and the second piconet; and
(d) the shared slave switching frequencies and relaying data between the first piconet and the second piconet while synchronizing with both the first piconet and the second piconet using allocated resources.

2. The scatternet implementation method according to claim 1, wherein:
the scatternet request includes information about a length of a superframe of the first piconet, and
the step (b) comprises the step of (e) the master of the second piconet adjusting a length of a superframe of the second piconet to the same value as the length of the superframe of the first piconet.

3. The scatternet implementation method according to claim 1, wherein the step (c) comprises the steps of:
(f) the shared slave switching the frequency to the frequency of the first piconet, relaying the scatternet request to the master of the first piconet, and being allocated resources by the first piconet; and
(g) the shared slave switching the frequency to the frequency of the second piconet after step (f), and being allocated resources, which do not overlap the resources allocated by the first piconet, by the master of the second piconet.

4. The scatternet implementation method according to any of claims 1 to 3, wherein, at step (d), a synchronization procedure is not performed when frequencies are switched between the first piconet and the second piconet to initiate communication.

5. A method of implementing a scatternet over a plurality of piconets performing IEEE 802.15.3 communication using different frequencies, comprising the steps of:
(a) a master of a first piconet transmitting a scatternet request to a shared slave, and the shared slave switching a frequency thereof to a frequency of a second piconet and relaying the scatternet request to a master of the second piconet;
(b) the master of the second piconet transmitting scatternet approval to the shared slave;
(c) the shared slave switching the frequency to a frequency of the first piconet, relaying the scatternet approval to the master of the first piconet, and being allocated resources, which do not overlap each other, by the masters of the first piconet and the second piconet; and
(d) the shared slave switching frequencies and relaying data between the first piconet and the second piconet while synchronizing with both the first piconet and the second piconet using allocated resources.

6. The scatternet implementation method according to claim 5, wherein:
the scatternet request includes information about a length of a superframe of the first piconet, and
the step (b) comprises the step of (e) the master of the second piconet adjusting a length of a superframe of the second piconet to the same value as the length of the superframe of the first piconet.

7. The scatternet implementation method according to claim 5, wherein the step (c) comprises the steps of:
(f) the shared slave switching the frequency to the frequency of the first piconet, relaying the scatternet request to the master of the first piconet, and being allocated resources by the first piconet; and
(g) the shared slave switching the frequency to the frequency of the second piconet after step (f), and being allocated resources, which do not overlap the resources allocated by the first piconet, by the master of the second piconet.

8. The scatternet implementation method according to any of claims 5 to 7, wherein, at step (d), a synchronization procedure is not performed when frequencies are switched between the first piconet and the second piconet to initiate communication.

9. A method of implementing a scatternet over a plurality of piconets performing IEEE 802.15.3 communication using different frequencies, comprising the steps of:
(a) a master of a first piconet transmitting a scatternet request to a shared slave, and the shared slave switching a frequency thereof to a frequency of a second piconet and relaying the scatternet request to a master of the second piconet;
(b) the master of the second piconet transmitting scatternet approval to the shared slave;
(c) the shared slave switching the frequency to the frequency of the first piconet and relaying the scatternet approval to the master of the first piconet; and
(d) the shared slave performing synchronization at the time of switching frequencies between the first and second piconets, and relaying data between the first and second piconets using resources allocated through the synchronization.
